(19) United States
(12) Patent Application Publication
(10) Pub. No.: US 2012/0241029 A1
(43) Pub. Date: Sep. 27, 2012

(54) Check Valve

(75) Inventor: Martino Carollo, Zane' (IT)

(73) Assignee: Ygros S.r.l., Marano Vicentino, Vicenza (IT)

(21) Appl. No.: 12/680,357

(22) PCT Filed: Sep. 22, 2008
(86) PCT No.: PCT/IB2008/053841

§ 371 Date: Apr. 12, 2010

(30) Foreign Application Priority Data
Oct. 4, 2007 (IT) BS2007A000150

(51) Int. Cl. F16K 15/02; F16K 31/08

(52) U.S. Cl. 137/528

(57) ABSTRACT

A check valve, in particular for foodstuff, chemical, biological and pharmaceutical applications. Valve allows passage of a fluid with limited losses of load and with low energy consumption. Valve is particularly suitable for use with corrosive and/or foodstuff fluids.

### FIELD OF THE INVENTION

This invention concerns a check valve, and in particular a check valve for applications in the food, chemical, biological and pharmaceutical sectors.

### BACKGROUND OF THE INVENTION

In particular, check valves are widely created in these fields for use in tubing in order to prevent a return flow with regard to a preset outflow. Such valves consist of a shutter element that is in direct contact with the process fluid.

In many applications the process fluids or liquids are particularly delicate from a chemical and biological viewpoint, as in the case of foodstuff liquids which are especially sensitive to the formation of bacteria or micro-organisms caused by stagnation of the liquid or the formation of foams and emulsions.

In other cases the liquids used are particularly aggressive from a chemical viewpoint and may lead to erosion of the shutter element.

So in state of the art solutions there are shutters in foodstuff-compatible and anticorrosive materials: these well known shutters are often activated by means of a spring loaded element. Spring loaded elements increase the valve's energy consumption as well as load loss, and spring loaded elements, directly involved with the fluid, often create turbulence and contribute to the creation of foams and emulsions. Moreover, spring loaded elements break down due to fatigue and/or corrosion. Breakdowns can lead to considerable damage to components mounted in series with the valve, since fragments of spring break off and are transported into circulation by the flow.

There are also well known shutter solutions in ferromagnetic materials that can be actuated by magnetic fields in such a way as to limit the valve's energy consumption. However these ferromagnetic materials are not always compatible with certain fluids, especially in the foodstuffs sector.

### SUMMARY OF THE INVENTION

The purpose of this invention is to create a check valve that eliminates the aforementioned drawbacks with reference to state of the art technique.

These drawbacks and limitations are resolved by a check valve in accordance with claim 1.

### BRIEF DESCRIPTION OF THE DRAWINGS

Other forms of creating the valve as per the invention are described in the subsequent claims.

Further features and the advantages of this invention will be rendered more comprehensible by the description below of its preferable but not limitative examples of implementation, in which:

FIG. 1 represents a perspective view in separate parts of a check valve in accordance with a form of implementation of this invention;

FIGS. 2-4 represent respectively lateral views, partially in section, of the valve in FIG. 1, in different functioning configurations;

FIG. 5 represents perspective and lateral views of a component of the valve in FIG. 1, in accordance with a form of implementation of this invention;

FIG. 6 represents perspective and lateral views of a component of the valve in FIG. 1, in accordance with a further form of implementation of this invention;

FIG. 7 represents a section view of a valve in accordance with a further form of implementation of this invention;

FIG. 8 represents a perspective view in separate parts of the valve in FIG. 7;

FIG. 9 represents a section view of a valve in accordance with a further form of implementation of this invention;

FIG. 10 represents a perspective view of separate parts of the valve in FIG. 9.

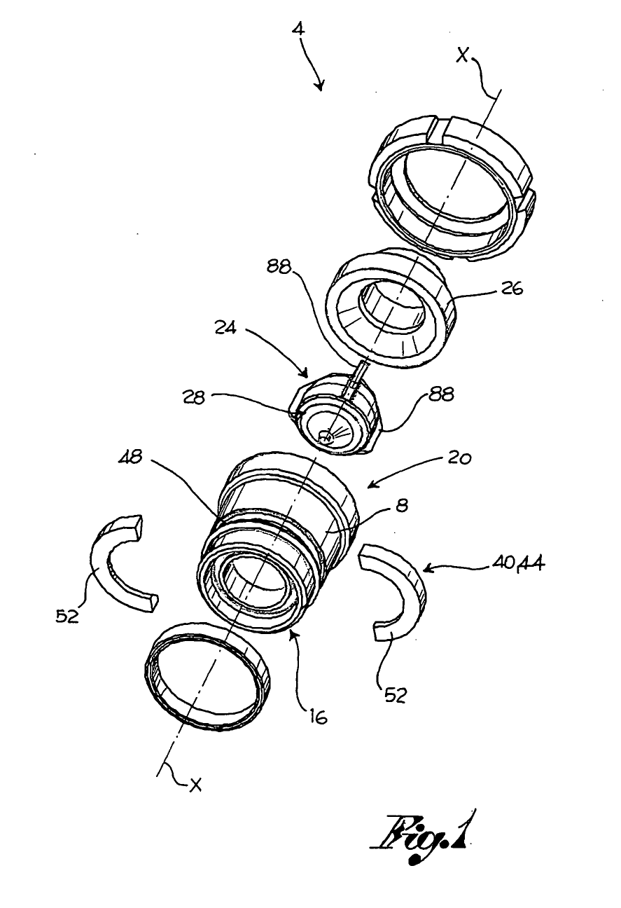

### DETAILED DESCRIPTION OF THE INVENTION

The elements or parts of elements common to the forms of implementation described below will be indicated by the same numerical references.

With reference to the aforementioned figures, number 4 globally indicates a check valve for regulating liquid outflow.

Valve 4 consists of a valve body 8 that delimits an outflow chamber 12 which extends from inlet 16 to outlet 20 of valve 4. In accordance with one form of implementation, the valve body 8 is substantially cylindrical along extension axis X-X.

Valve 4 consists of a shutter 24, housed in said outflow chamber 12, suitable for closing inlet 16 of the valve in correspondence to closure portion 28 facing said inlet 16.

Preferably the shutter 24, in correspondence to closure portion 28, consists of a gasket 29, e.g. an O-ring, to guarantee a hermetic seal against valve body 8.

In correspondence to the said outlet 20, the valve body is associated with a plate 26 such as to permit insertion and subsequent locking of the shutter in outflow chamber 12.

Advantageously, shutter 24 includes at least one portion in ferromagnetic material; for example the shutter consists of an internal nucleus in a ferromagnetic material, coated externally with a layer of polymeric material, compatible with foodstuffs or pharmaceutical fluids and with good resistance to wear and abrasion. For example the nucleus in ferromagnetic material may be coated with Teflon. In the description, “ferromagnetic material” also means a permanent magnet.

Preferably the said shutter 24 is made entirely of ferromagnetic stainless steel.

Advantageously, valve 4 includes means for the generation of magnetic field 40, the said means 40 being set on valve body 8, external to outflow chamber 12, in such a way as to generate a magnetic field which influences shutter 24 and is not influenced by the flow of fluid crossing outflow chamber 12.

In accordance with one form of implementation, the said means for generating a magnetic field 40 are set coaxially to valve body 8 and extension axis X-X, in correspondence to the said inlet 16.

In accordance with one form of implementation, the said means 40 consist of a toroidal magnet 44 set coaxially to the valve body 8 in correspondence to an annular housing 48 of valve body 8, opposite the said outflow chamber 12. In other words, valve body 8, on an external wall opposite outflow chamber 12, consists of annular housing 48 suitable for housing a toroidal magnet 44.

Preferably the said toroidal magnet 44 is created in at least two halves or semi-rings 52, set coaxially with regard to valve body 8.

Preferably valve body 8 includes an abutment portion suitable to abut with closure portion 28 of the shutter to close inlet 16 of valve 4.

Preferably the abutment portion 60 has a chamfer 64 and the shutter 24 has a closure portion 28 at least partially counterprofiled with regard to chamfer 64.

Preferably housing 48 of magnetic means 40 includes a conical portion 68 counterprofiled with regard to chamfer 64. In accordance with other possible forms of implementation, housing 48, with regard to a section plane passing through said extension axis X-X, has a square, rectangular, circular, elliptical or flat section.

Preferably magnet 44 in turn has a countersinking 72 suitable for insertion with a coupling of form in conical portion 68.

In accordance with one form of implementation, valve body 8 includes sealing means 76 suitable for locking in place the magnetic means 40 and preventing contact between magnetic means 40 and the external environment of valve 4.

For example, sealing means 76 consist of a ring gasket 80 fitted on magnetic means 40.

In accordance with one favoured form of implementation, shutter 24 is counterprofiled with regard to the internal walls of outflow chamber 12 in such a way as to delineate with the said chamber a passage of constant section.

In this way the speed of liquid outflow remains as constant as possible and the formation of foams and/or emulsions is avoided.

Advantageously, check valve 4 includes at least one fin 88 suitable for subdividing the incoming flow into a plurality of flows and for creating a guide and an alignment for the shutter.

In accordance with one possible form of implementation, shutter 24 includes at least one fin 88 and, preferably, includes a plurality of fins 88.

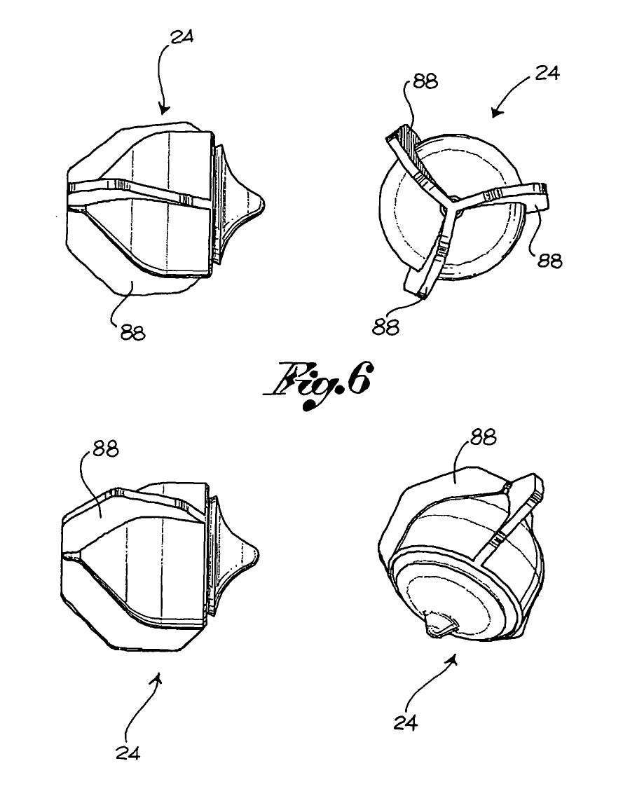

In accordance with one form of implementation (FIG. 5), fins 88 are substantially parallel to the prevalent extension axis X-X.

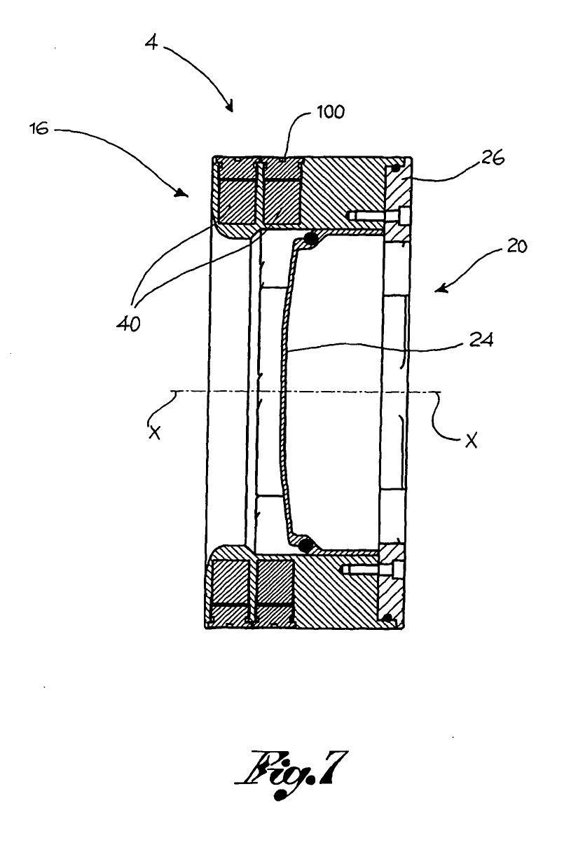

In accordance with a further and favoured form of implementation (FIG. 6), fins 88 are twisted with regard to said extension axis X-X in such a way as to bring about rotation of shutter 24 under the thrust of the liquid flow.

In accordance with one possible form of implementation, shutter 24 includes at least two fins 88; preferably the shutter includes three fins set equally angularly spaced along an external side wall of shutter 24.

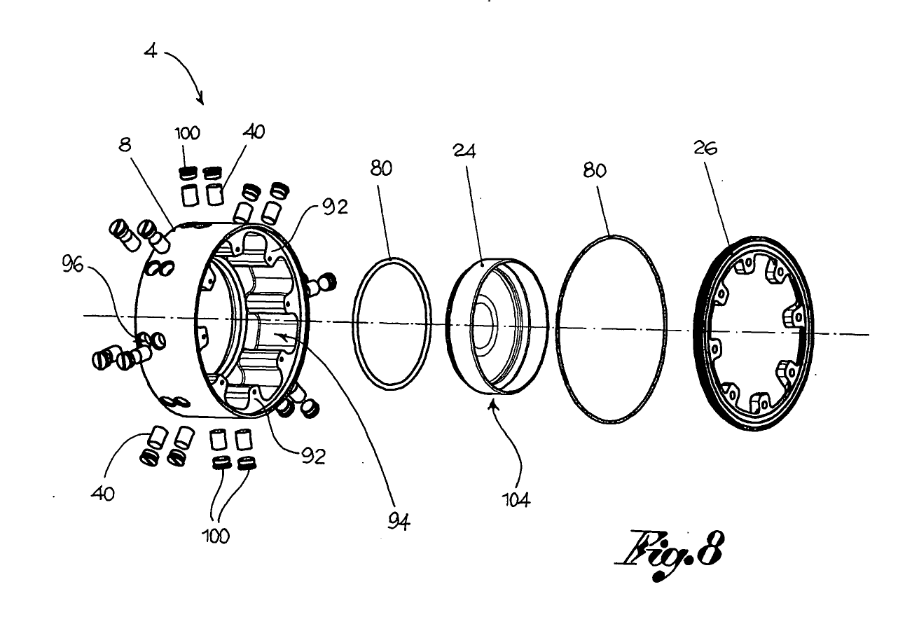

In accordance with a further advantageous form of implementation, the said fins 88 are obtained from valve body 8. For example, valve body 8 (FIG. 7-8) includes a plurality of protuberances 92, preferably radial, facing outflow chamber 12. Advantageously the said protuberances 92 have the function of fins 88, interfering with the flow through outflow chamber 12 in such a way as to subdivide the inlet flow into a plurality of flows, creating a guide and an alignment for shutter 24.

In particular, two protuberances 92, adjacent or consecutive, form throat 94 which represents the area of the passage of a flow.

Preferably the said protuberances 92 extend axially, which is to say parallel to said extension axis X-X. Protuberances 92 are advantageously hollow in such a way as to house, in special cavities 96, the means for generating magnetic field 40, for example in the form of cylindrical or disc magnets.

The protuberances 92 are closed by outflow chamber 12 in such a way that the fluid of valve 4 cannot enter the said cavities 96; cavities 96 disembogue towards the exterior of valve body 8 in such a way as to be accessible from the exterior. In this way it is possible to insert magnets 40 from outside valve body 8 and lock them in cavities 96 with, for example, bolts or pins 100.

Preferably the valve body 8 includes a plurality of protuberances 92, set angularly step-by-step. Also preferably, valve body 8 equipped with protuberances 92 is associated with a shutter 24, having a lateral area 104, cylindrical with regard to extension axis X-X.

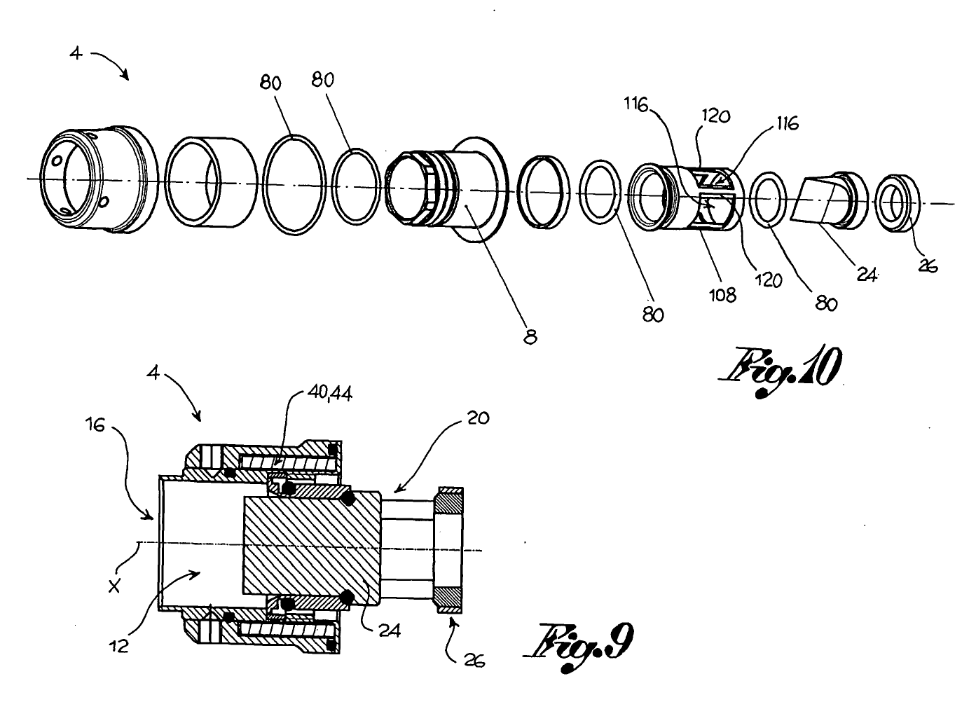

In accordance with a further form of implementation (FIGS. 9-10), shutter 24 is housed in outflow chamber 12, the former equipped with shutter guide 108. For example shutter 24 includes central divider 112 to subdivide the flow. Shutter guide 108 includes for example a cylindrical portion equipped with windows 116 delimited angularly by bars 120. The combination of windows 116 and bars 120 subdivides the inlet flow into a plurality of flows, creating a guide and alignment for shutter 24.

There follows a description of the functioning of a valve in accordance with the invention.

In particular the means of generating the magnetic field 40 exert a force of attraction on shutter 24 in such a way as to bring it to closure configuration (FIG. 4).

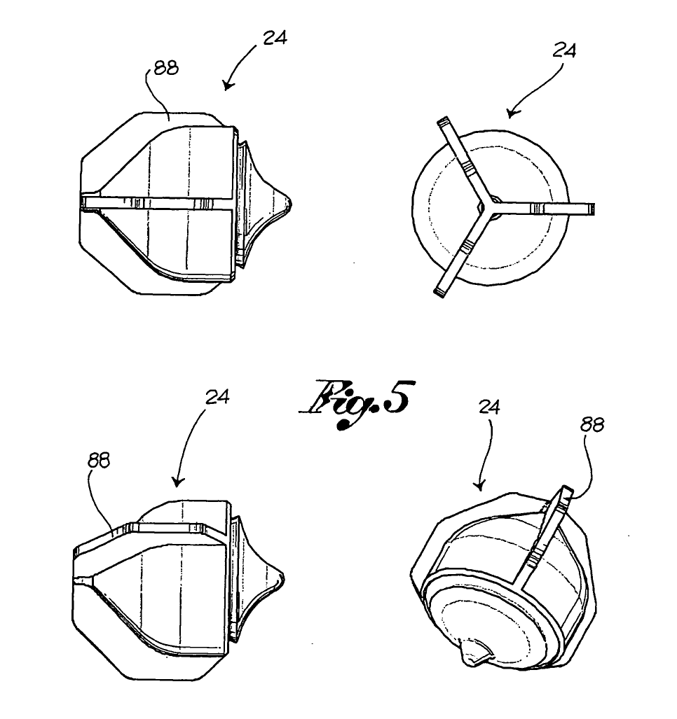

When the force exerted by the inlet fluid on closure portion 28 of shutter 24 exceeds the force of magnetic attraction and the returning force of the shutter due to the pressure of outgoing fluid, shutter 24 opens and permits the passage of fluid (FIG. 3).

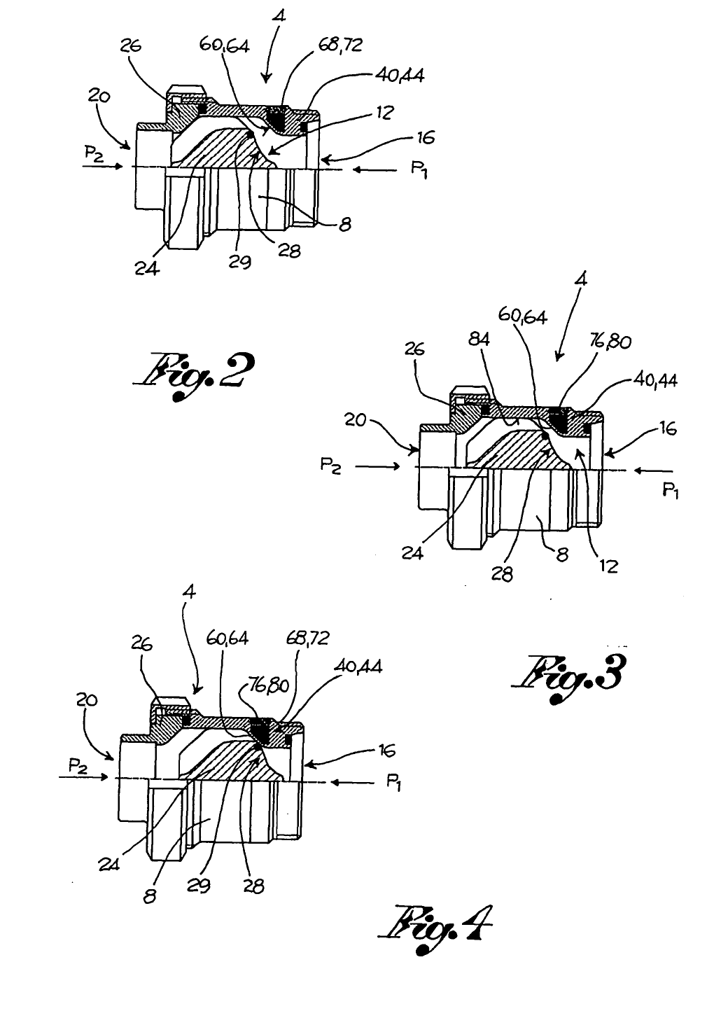

Advantageously, subsequent to the distancing of shutter 24 from closure position, the magnetic force of attraction acting thereon diminishes and therefore, the inlet fluid pressure being equal, the opening effect of shutter 24 tends automatically to increase until the shutter is in maximum open position (FIG. 2).

The fluid is therefore free to pass into valve body 8 through a constant passage section which, limiting variations of fluid speed, contributes to achieving laminar flow, without turbulence and the consequent formation of foams and emulsions.

In accordance with a further possible form of implementation, shutter 24 is shifted from open to closed mode (and vice versa) by external actuation with regard to outflow chamber 12, in such a way as to overcome the action of the magnet.

Shutter 24 equipped with twisted fins can rotate under the thrust of the incoming fluid; this rotation prevents the formation of stagnant liquid.

When the force exerted by the incoming fluid is less than that of the outgoing fluid, added to the force of magnetic return of shutter 24, the shutter goes back to closure configuration and the passage of fluid is interrupted.

Also in closure, the return force due to magnet 44 increases on the approach of shutter 24 to the magnet itself; so the closure effect is automatically increased, improving valve efficiency.

As may be appreciated from the foregoing, the check valve as per the invention overcomes the drawbacks of current techniques.

In particular, the valve offers reduced energy consumption, thanks to the low energy required to activate it and the low drop of pressure between inlet and outlet.

The valve permits a very regular flow of liquid with minimal losses of load and therefore with a minimal drop in pressure between valve inlet and outlet.

The valve components have a very slight roughness, thus limiting fluid turbulence and consequent losses of load, as well as the formation of foams and emulsions.

The valve can create a laminar flow which further limits the formation of foams and emulsions.

Moreover the geometry of the shutter and the valve body create a constant passage section for the fluid in such a way that the flow has a constant speed in passing through the valve.

The valve in accordance with this invention has high resistance to mechanical and chemical corrosion due to low turbulence and the possibility of using stainless steels that are resistant to chemical and mechanical aggression as well as being compatible with applications for foodstuff, chemical and biological fluids.

The presence of the twisted fins creates a slight rotation of the shutter which prevents any formation of stagnant points or static contact of the shutter with the valve body which could lead to the formation of dirt.

Advantageously the magnet is positioned outside the valve body in such a way as to avoid contact with the liquid passing through the valve. In this way the magnet is not subject to any kind of mechanical and/or chemical corrosion.

Advantageously, the magnet is in turn protected from external corrosive agents by a chemical surface treatment and a gasket.

Advantageously, the magnet exerts a force of attraction on the shutter in the closure configuration of the valve. In other words, in closure configuration the force of attraction between the shutter and the magnet is maximum to the extent that the distance between the two components is minimum. Whereas when the valve is open the force of attraction between the magnet and the shutter is minimum inasmuch as the distance between the components is maximum.

This functioning is unlike the functioning of traditional spring-loaded non-return valves where the elastic power of the spring is minimum in closure and maximum in opening, thus increasing the energy consumption of the valve.

A sector technician, with view to meeting contingent and specific needs, could carry out numerous modifications and variations with regard to the valves described above, but without straying from the context of the invention as defined by the following claims.

1-29. (canceled)

30. Check valve for regulating outflow of a fluid, including
a valve body that delimits an outflow chamber which extends from an inlet to an outlet of the valve,
a shutter housed in said outflow chamber suitable for blocking the said inlet in correspondence to a closure portion facing the said inlet in which the shutter includes at least one portion in ferromagnetic material, wherein
the valve includes the means for generation of a magnetic field, the said means being set out on the valve body, externally to the said outflow chamber, in such a way as to generate a magnetic field that influences shutter and is not affected by the flow crossing the outflow chamber,
the valve includes at least one fin suitable for subdividing the inlet flow into a plurality of flows and creating a guide and alignment for the shutter.

31. Valve in accordance with claim 30, in which the shutter includes a plurality of fins suitable for subdividing the inlet flow into a plurality of flows.

32. Valve in accordance with claim 30, in which the shutter includes three fins set equally angularly spaced along a lateral external wall of the shutter.

33. Valve in accordance with claim 31, in which the fins are substantially parallel to the prevalent extension axis.

34. Valve in accordance with claim 31, in which the said fins are twisted with regard to the said extension axis in such a way as to bring about rotation of the shutter under the action of the thrust of fluid flow.

35. Valve in accordance with claim 30, in which at least one fin is obtained from the valve body.

36. Valve in accordance with claim 35, in which the valve body includes a plurality of radial protuberances facing the outflow chamber which carries out the function of the said fins in such a way as to subdivide the inlet flow in a plurality of flows and create a guide and an alignment for the shutter.

37. Valve in accordance with claim 36, in which at least two protuberances, adjacent or consecutive, delimit a throat that creates the section of flow passage.

38. Valve in accordance with claim 36, in which said protuberances extend axially, parallel to an extension axis of the valve body.

39. Valve in accordance with claim 36, in which the protuberances are hollow in such a way as to house, in cavities, said means for generating a magnetic field.

40. Valve in accordance with claim 39, in which the protuberances are closed on the side of the outflow chamber and the cavities disembogue towards the exterior of the valve body.

41. Valve in accordance with claim 39, in which the magnets are housed in the said cavities and fixed by bolts or pins.

42. Valve in accordance with claim 30, in which the shutter is housed in the outflow chamber, the former equipped with an appropriate shutter guide.

43. Valve in accordance with claim 42, in which the shutter includes a central divider for subdividing the flow.

44. Valve in accordance with claim 42, in which the shutter guide includes a cylindrical portion equipped with windows delimited angularly by bars in such a way as to subdivide the inlet flow into a plurality of flows and create a guide and alignment for the shutter.

45. Valve in accordance with claim 30, in which the said means for generating a magnetic field are set coaxially to the valve body in correspondence to the said inlet.

46. Valve in accordance with claim 45, in which the said means for generating a magnetic field include a toroidal magnet set coaxially to the valve body in correspondence to an annular housing of valve body opposite the said outflow chamber.

47. Valve in accordance with claim 30, in which said magnet is created in one single piece.

48. Valve in accordance with claim 46, in which said magnet is created in at least two pieces or half-rings set coaxially with regard to the valve body.

49. Valve in accordance with claim 30, in which the valve body includes an abutment portion suitable to abut with closure portion of shutter, the abutment portion having a chamfer to favour hermetic closure of the inlet.

50. Valve in accordance with claim 49, in which the shutter includes a closure portion at least partially counterprofiled with regard to the said chamfer.

51. Valve in accordance with claim 46, in which housing of the said magnetic means includes a conical portion counterprofiled with regard to the chamfer.

52. Valve in accordance with claim 51, in which the magnet has a countersinking suitable for insertion with coupling of form in the conical portion.

53. Valve in accordance with claim 30, in which the valve body includes sealing means suitable for locking the magnetic means in place and preventing contact between the magnetic means and the external environment of the valve.

54. Valve in accordance with claim 53, in which the said sealing means include a ring gasket fitted on the magnetic means.

55. Valve in accordance with claim 30, in which said shutter includes a portion in ferromagnetic material covered with a layer of foodstuffs-compatible polymeric material.

56. Valve in accordance with claim 30, in which said shutter is in a ferromagnetic stainless steel.

57. Valve in accordance with claim 30, in which said shutter is counterprofiled with regard to the internal walls of outflow chamber in such a way as to form with the said chamber a passage with a constant section.

58. Valve in accordance with claim 30, in which the shutter, in correspondence to the closure portion, includes a gasket to ensure a hermetic seal against the valve body.
